(19) United States
(12) Patent Application Publication
(10) Pub. No.: US 2002/0182431 A1
(43) Pub. Date: Dec. 5, 2002

(54) Calcium borate treated wood composite

(76) Inventors: Howard Wayne Hatton, Tualatin, OR (US); Eugene M. Hibbs, Philomath, OR (US)

Correspondence Address: Paul M. Denk, 763 South New Ballas Road, St. Louis, MO, 63141, US

(21) Appl. No.: 10/120,228

(22) Filed: Apr. 11, 2002

Related U.S. Application Data
(60) Provisional application No. 60/285,311, filed on Apr. 23, 2001.

(51) Int. Cl. B32B 5/02; B32B 27/04; B32B 27/12; B27K 1/00

(52) U.S. Cl. 428/541

(57) ABSTRACT

A method of making a borate treated wood composite board or article, (such as particleboard, waferboard, oriented strandboard, medium density fiberboard, or hardboard) by applying an adhesive resin and calcium borate to wood particles, fibers, wafers or strands to produce treated wood particles, fibers, wafers, or strands. The treated wood particles, fibers, wafers or strands to produce treated wood particles, fibers, wafers, or strands are formed into a mat and consolidated under heat and pressure to produce a treated wood composite panel or article. The calcium borate is particularly suitable for the purpose of making treated wood composite board or articles due to the low solubility of the calcium borate. The low solubility of the calcium borate minimizes the interference of the borate with leaching after the article is installed or used in an exterior application in contact with water. Further, calcium borate should be considered to be less toxic to the environment that the alternative very low solubility borate, zinc borate, due to the substitution of the less toxic calcium ion for the zinc ion present in the zinc borate.

### CROSS-REFERENCE TO RELATED APPLICATIONS

This application claims priority to Provisional Application No. 60/285,311 filed Apr. 23, 2001 which is entitled “Calcium Borate Treated Wood Composite” and which is incorporated herein by reference.

### STATEMENT REGARDING FEDERALLY SPONSORED RESEARCH OR DEVELOPMENT

Not Applicable.

### BACKGROUND OF THE INVENTION

The present invention relates to a borate treated composite board or article. The present invention applies to particleboard, waferboard, oriented strandboard, medium density fiberboard or hardboard and the method of producing the same wherein borate is added as calcium borate particles. The calcium borate may be added to the wood either as a dry powder or suspended in a liquid resin or in a liquid wax emulsion.

It is known that berates are effective in preserving wood against fungal decay and that borates exhibit lower mammalian toxicity than other wood preservatives such as ACA and CCA (ammoniacal copper arsenic or chromated copper arsenic). Much prior work has been done to pre-treat wood particles or wafers for use in the manufacture of a wood composite board or article.

For example, Pat. No. 4,241,133 to Lund describes treated wood used for making board wherein the preservative is compatible with any suitable adhesive such as phenol formaldehyde or the like. The patent also states that the binder, wax and other additives may be added separately or in any sequence.

U.S. Pat. No. 4,145,242 to Chow taught to use a boron compound applied to the wood to preserve the glue bondability of the wood during drying and storage. It was found that the bond could be improved provided that the amount of borax on the surface of the wood is within a very specific range. Addition of borax outside the range was found to be detrimental to bondability.

U.S. Pat. No. 4,879,083 to Knudson taught a method of making a chemically treated consolidated wood product from wood particles comprising applying a phenol formaldehyde resin and at least one particulate boron compound selected from the group consisting of anhydrous borax and zinc borate (3ZnO.2B₂O₃). The patent teaches that it is the relatively low solubility of the anhydrous borax and zinc borate that prevents these compounds from interfering with the resin and wood bond. The patent also teaches that the relatively low solubility of these compounds makes them resistant to water leaching and therefore more suitable as a preservative in circumstances of exposure to water. However, zinc borate is toxic to wildlife (such as fish), and is subject to regulations, such as reporting spills, worker exposure levels, etc.

U.S. Pat. No. 5,763,338 to Sean taught a method of incorporating a low solubility borate into a wood based composite article in 1% to 10% by weight of the furnish with the use of a flow agent.

### BRIEF SUMMARY OF THE INVENTION

No one has ever used calcium borate (Ca(BO₂)₂) as a preservative treatment in composite boards or articles. Knudson (U.S. Pat. No. 4,879,083) teaches that zinc borate and anhydrous borax are useful and effective preservatives in composite boards due to their low solubility. The low solubility of these compounds reduces interference with resin bonding and improves resistance to leaching when boards are exposed to water. Calcium borate exhibits very low solubility like zinc borate and hence is leach resistant under water exposure, but also has the added advantage of eliminating the metal zinc from the boron compound while substituting the less reactive calcium. Anhydrous borax does not contain any zinc. However, it is more soluble and not as leach resistant as either zinc borate or calcium borate.

The wood composite is made by forming a wood mixture comprising wood particles, a bonding agent, a moisture inhibitor, and a preservative. The preservative is chosen from the group consisting of calcium borate, colmanite, synthetic colmanite, and combinations thereof, and is added to the wood mixture in an amount equal to about 0.20 wt % to 3 wt % of the wood mixture, and more preferably, in an amount equal to about 0.20 wt % to about 0.83 wt %. The wood mixture is then formed into a mat, and the mat is pressed under heat and pressure to produce a composite board from the mixture.

### BRIEF DESCRIPTION OF THE SEVERAL VIEWS OF THE DRAWINGS

FIG. 1 is a graph charting the efficacy of calcium borate as a wood preservative.

### DETAILED DESCRIPTION OF THE INVENTION

The following detailed description illustrates the invention by way of example and not by way of limitation. This description will clearly enable one skilled in the art to make and use the invention, including what we presently believe is the best mode of carrying out the invention.

A borate treated wood composite board or article, (such as particleboard, waferboard, oriented strandboard, medium density fiberboard, or hardboard) is produced by applying an adhesive resin and calcium borate, colmanite or synthetic colmanite to wood particles (including fibers, wafers or strands) to produce treated wood particles. The resin is preferably a phenolic resin or polymeric isocyanates (polyurethanes), both of which stand up well to exterior (outdoor) environments. The treated wood particles are formed into a mat and consolidated under heat and pressure to produce a treated wood composite panel or article. The wood particles can be treated, and the composite board or articles formed, for example, in the manner described in Knudson, U.S. Pat. Nos. 4,879,083; Sean, 5,763,338; or Lund, 4,241,133, all of which are incorporated herein by reference.

A preferred method of making the wood composite of the present invention includes initially preparing wood residuals or fractions used to make the composite board. The wood residuals or fractions include planner shavings, saw dust, chips, and the like are ground or refined to a desirable geometry conducive to the process. Other forms of coarse wooden components may be utilized, such as, wood chips, wood slices, wood veneer flakes, and loose veneer sheets, flakes, splinters, dust, flour, or strands. The wood particles are dried to a moisture content of between about 5% and about 10%.

Once the wood particles are dried, they are ready to be blended with bonding agents, moisture inhibitors, and preservatives. The mixture which is blended together is about 4-9% bonding agent, about 0.25%-2% moisture inhibitor, about 0.2-3% preservative, and the rest wood particles.

The bonding agents are chosen to meet the conditions of exposure. Generally bonding agents are divided into two major groups—those used for interior exposures and those used for external exposures. Some external exposure suited bonding agents are required for interior exposure when a damp environment is present during the service life of the wood composite. This process uses an exterior grade resin, which can, for example, be a polymeric isocyanate (i.e., a polyurethane) or a phenolic resin.

Moisture inhibitors generally comprise a paraffin wax which has been emulsionized to provide ease in dosing.

Preservatives are utilized to prevent degradation from microbiological life forms and insects. Preservatives can be dosed or metered by dry addition or in liquid form, such as a slurry or suspended with other ingredients.

After the wood particles have been mixed with the bonding agents, moisture inhibitors, and preservatives, the mixture can be dried in a post-blending drying operation if speed is of the essence in the pressing process. In a post blending drying operation, all or part of the moisture added to the mixture is removed from the mixture. Otherwise, after the ingredients are mixed together, they are laid in uniform thickness to form a mat. The mat can be pre-shaped to fit a desired shape of the composite product. The mat preferably is laid to have a consistent density of 30-50 lbs/foot and/or a consistent thickness of about 0.25″ to about 1.5″. Thinner composite products are generally used for paneling and thicker composite products can be cut into trim boards or structural members.

The mat is then subjected to heat (of between about 260° F. and about 360° F.) and pressure (of between about 100 psi and about 300 psi of mat area) for a period of time to guarantee the cure of the bonding agent. Generally, the thinner the mat, the shorter the period of time and the lower the heat required to cure the bonding agent.

The preferred preservative is calcium borate, colmanite, synthetic colmanite, or combinations thereof. Calcium borate is particularly suitable for the purpose of making treated wood composite board or articles due to the low solubility of the calcium borate. The low solubility of the calcium borate minimizes the interference of the borate with leaching after the article is installed or used in an exterior application in contact with water. Further, calcium borate should be considered to be les toxic to the environment than the alternative very-low solubility borate, zinc borate, due to the substitution of the less toxic calcium ion for the zinc ion present in the zinc borate.

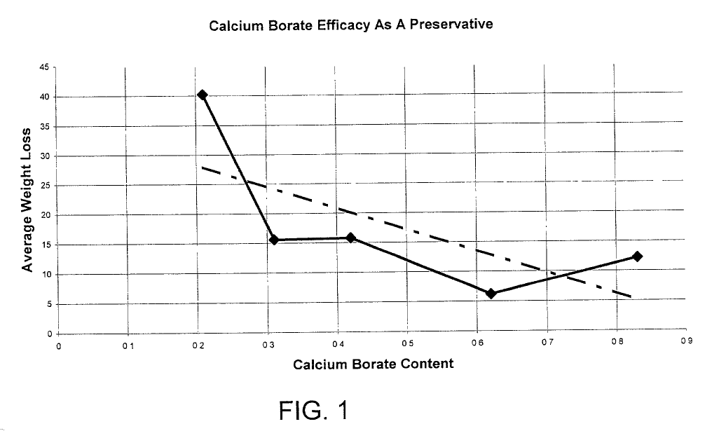

Calcium borate is a low solubility borate and does not interfere with the resin bonding in the manufacture of the composite board or article. Furthermore, calcium borate is of lower solubility than both zinc borate or anhydrous borax (sodium borate) and thus more leach resistant. Calcium borate has a distinct advantage over anhydrous borax in the lower solubility and improved leach resistance of the calcium borate compared to the anhydrous borax. Calcium borate has been demonstrated to be effective in preventing or reducing wood decay when incorporated into the composite board or article. The calcium borate was tested at different concentrations, measured as a percentage by weight of the wood particles. The effectiveness of the calcium borate was tested in accordance with the ASTM D-1413 soil block test. The results of the test are shown below in Table 1 and the graph of FIG. 1. The graph shows the data points from the data produced below, as well as a linear interpolation of the data points.

TABLE 1
Calcium Borate Added To A Wood Composite
Weight Loss When Exposed To Wood Decay Fungus

| | Average Weight Loss % |
|---|---|
| % Calcium Borate By Weight | (ASTM D-1413 Soil Block) |
| 0% protection (control) | 55.1 |
| 0.42% zinc borate (control) | 12.6 |
| 0.21 | 40.2 |
| 0.31 | 15.6 |
| 0.42 | 15.8 |
| 0.62 | 6.2 |
| 0.83 | 12.2 |

The above tests show that calcium borate is effective in improving resistance to decay fungus at all levels tested, and that as the calcium borate concentration is increased, weight loss decreases. In fact, by comparing the zinc borate control against the 0.42% calcium borate test, it can be seen that the calcium borate is slightly more effective than the zinc borate.

Calcium Borate Advantage Over Zinc Borate

Borates are known to exhibit low mammalian toxicity. Calcium borate is environmentally benign in comparison to zinc borate. Zinc borate is listed in guidance and regulatory listings, such as the Worker Exposure Hazard Score (IRCH), the North American Emergency Response Guide Book—Guide #171; and the Federal Requirements of Reportable Spill Quantities. Calcium borate, on the other hand, is not listed in any of these guidance and regulatory listings. Additionally, the use of elemental zinc is regulated through the agencies shown below in Table 2, whereas elemental calcium is not so regulated.

TABLE 2
Regulatory Listings

| | Elemental | Elemental |
|---|---|---|
| Regulated Listing | Zinc | Calcium |
| Environmental Protection Agency's Benchmark | Yes | No |
| Levels For Metals in Stormwater Analysis | | |
| Coalition of Northeastern Governors and Council | Yes | No |
| of State Governments Metal Content in Food | | |
| Packaging Material | | |
| EPA's Safe Levels for Drinking Water | Yes | No |
| Material Releases to the Environment (exceeding | Yes | No |
| 1000 lbs) | | |
| SARA Title III, Sec. 313—Toxic Chemical Lists | Yes | No |

Additionally, calcium borate is much less toxic than zinc borate. It was determined that calcium borate had an acute LC₅₀ of more than 500 mg/L in tests upon fathead minnows, whereas, zinc borate was determined to have an acute LC₅₀ of around 18.7 mg/L. Based on the standard toxicity chart shown below in Table 3, zinc borate is considered to be slightly toxic to fish, whereas the calcium borate is considered to be practically nontoxic to fish.

TABLE 3
Toxicity Chart
Categories of Ecotoxicity

| Toxicity Category | Fish LC₅₀ (mg/L) |
|---|---|
| Very highly toxic | <0.1 |
| Highly toxic | 0.1-1.0 |
| Moderately toxic | 1.0-10 |
| Slightly Toxic | >10-100 |
| Practically nontoxic | >100 |

As various changes could be made in the above constructions without departing from the scope of the invention, it is intended that all matter contained in the above description or shown in the accompanying drawings shall be interpreted as illustrative and not in a limiting sense.

1. A method of making preservative treated wood composite board or article with minimal environmental impact, the method comprising:
forming a wood mixture by blending wood particles with a bonding agent, a moisture inhibitor, and a preservative; the preservative being chosen from the group consisting of calcium borate, colmanite, synthetic colmanite, and combinations thereof; the preservative being added to the wood mixture in an amount equal to about 0.20 to 3 wt % of the wood mixture;
forming a mat of the wood mixture;
pressing the mat under heat and pressure.

2. The method of claim 1 wherein the preservative is added to the wood mixture in an amount equal to about 0.20 wt % to about 0.83 wt %.

3. The method of claim 1 wherein the wood particles are chosen from the group consisting essentially of wood particles, fibers, wafers, strands, planner shavings, saw dust, chips, wood chips, wood slices, wood veneer flakes, loose veneer sheets, flakes, splinters, dust, flour, strands, and combinations thereof.

4 The method of claim 1 wherein the preservative is added to the wood mixture as a dry powder.

5 The method of claim 1 wherein said preservative is added to the wood mixture mixed or suspended in a liquid resin.

6 The method of claim 5 wherein the moisture inhibitor is a liquid wax emulsion.

7 The method of claim 1 wherein said composite board or article is a reconstituted wood product such as particle board, oriented strandboard, medium density fiberboard, or hardboard.

8. A treated wood composite board or article made according to the steps of:
forming a wood mixture by blending wood particles with a bonding agent, a moisture inhibitor, and a preservative; the preservative being chosen from the group consisting of calcium borate, colmanite, synthetic colmanite, and combinations thereof; the preservative being added to the wood mixture in an amount equal to about 0.20 to 3 wt % of the wood mixture;
forming a mat of the wood mixture; and
pressing the mat under heat and pressure.
